(19) United States
(12) Patent Application Publication
(10) Pub. No.: US 2015/0025693 A1
(43) Pub. Date: Jan. 22, 2015

(54) SYSTEM AND METHOD OF TEMPERATURE CONTROL

(71) Applicant: International Business Machines Corporation, Armonk, NY (US)

(72) Inventors: Ann Chen Wu, Hopewell Junction, NY (US); Chai Wah Wu, Hopewell Junction, NY (US)

(73) Assignee: International Business Machines Corporation, Armonk, NY (US)

(21) Appl. No.: 13/947,799

(22) Filed: Jul. 22, 2013

(51) Int. Cl. G05D 23/19; F24F 11/00

(52) U.S. Cl. CPC G05D 23/1917; F24F 11/0009
USPC 700/278

(57) ABSTRACT

A structure and method for temperature control includes determining a schedule for a climate control device needed for an inside temperature to reach a desired temperature, determining a perceptual temperature factor based on at least the schedule and the inside temperature, adjusting the desired temperature based on the perceptual temperature factor, and after the adjusting the desired temperature, repeating the determining the schedule.

### FIELD OF THE INVENTION

The present invention relates generally to a system and method for temperature control.

### BACKGROUND OF THE INVENTION

### Description of the Related Art

Intelligent thermostats today contain algorithms to monitor the occupant's habits and predict thermostat settings, predict how long it takes to reach a desired thermostat temperature, and estimate how the outside temperature affects energy usage.

### SUMMARY OF THE INVENTION

Conventional thermostats do not take into account the perceptual aspect of heating and cooling. All heater and air conditioning units generate air at a much higher or lower temperature than typical thermostat temperature settings. Indeed, many heaters or AC units only produce air at a fixed (or a narrow range of) temperature. That is, a heater or AC that turns on more often will “feel” warmer or cooler than what the thermostat thermometer indicates. This may create a less than ideal environment which can cause, for example, discomfort to building occupants.

There is a nonlinear perceptual mapping that connects the rate of heating/cooling versus the temperature perceived by occupants in the room. This mapping can also depend on other factors such as the amount of (sun)light, the humidity in the room and the temperature and flow rate at the output of the climate control device. An exemplary aspect of the invention leverages this notion to design a thermostat that is more consistent in comfort to the occupants, regardless of the outside temperature, the inside temperature, the desired temperature and, optionally, other factors as stated above.

In view of the foregoing and other exemplary problems, drawbacks, and disadvantages of the conventional systems, an exemplary aspect of the invention is directed to providing more consistent comfort in a climate control device such as HVAC (heating, ventilation and air conditioning) systems of human-occupied buildings. A climate control device or an HVAC device can be heaters, furnaces, chillers, fans and other devices used to regulate the temperature of an area.

An exemplary aspect of the invention includes a method of controlling a temperature of an area. The method includes determining a perceptual temperature factor based on at least the schedule and the inside temperature, adjusting the desired temperature based on the perceptual temperature factor, and after the adjusting the desired temperature, determining a schedule for a climate control device needed for the inside temperature to reach the adjusted desired temperature.

Another exemplary aspect of the invention is directed to a thermostat including a temperature sensor input configured so as to receive a temperature of an area, a desired temperature input unit, a control unit configured so as to output a control signal to an climate control device, and a processor configured so as to determine a schedule for the climate control device and which adjusts the desired temperature based on a perceptual temperature factor. The perceptual temperature factor is determined based on the temperature of the area and the schedule.

Yet another exemplary aspect of the invention includes, in addition to the previous exemplary aspect, a temperature sensor unit configured so as to receive the temperature outside of the area, and a module to determine the perceptual temperature factor based on the temperature of the area, and the outside temperature.

Yet another exemplary aspect of the invention includes, in addition to the previous exemplary aspect, a humidity sensor unit configured so as to receive the humidity, and a module to determine the perceptual temperature factor based on the temperature of the area, the outside temperature and the humidity of the area.

Yet another exemplary aspect of the invention includes a non-transitory programmable storage medium tangibly embodying a program of machine-readable instructions executable by a digital processing apparatus to perform a method. The method includes receiving a desired temperature and a temperature of an area, determining a schedule for a climate control device based at least on the desired temperature and the temperature of the area, determining a perceptual temperature factor based on at least the schedule and the temperature of the area, adjusting the desired temperature based on the perceptual temperature factor, after the adjusting the desired temperature, repeating the determining the schedule, and sending instructions to the climate control device based on the schedule.

The above exemplary aspects of the invention may provide a thermostat that is more consistent in comfort to the occupants, regardless of the outside temperature, the inside temperature and the desired temperature.

### BRIEF DESCRIPTION OF THE DRAWINGS

The foregoing and other purposes, aspects and advantages will be better understood from the following detailed description of embodiments of the invention with reference to the drawings, in which:

FIG. 1 illustrates an exemplary system including a thermostat 1, sensor(s) 2 and HVAC system(s) 3; and

FIG. 2 illustrates a method of controlling a temperature of an area.

### DETAILED DESCRIPTION OF EXEMPLARY EMBODIMENTS OF THE INVENTION

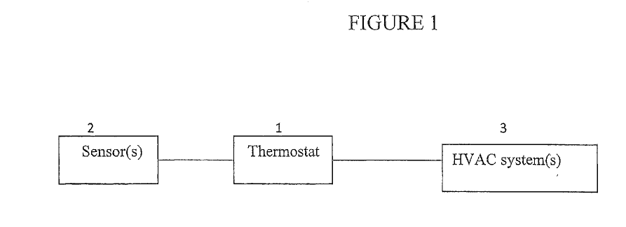

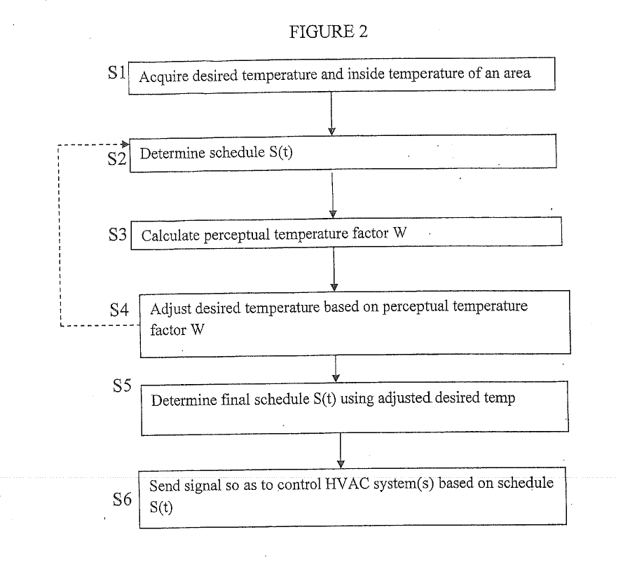

Referring now to the drawings, and more particularly to FIGS. 1-2, there are shown exemplary embodiments of the method and structures according to the present invention.

An exemplary aspect of the invention leverages the nonlinear perceptual mapping that connects the rate of heating/cooling versus the temperature perceived by occupants in the room. This can provide a thermostat/controller 1 that is more consistent in comfort to the occupants, regardless of the outside temperature, the inside temperature and the desired temperature. While exemplary embodiments will be described in reference to an HVAC system 3, any system(s) affecting the air or climate of an enclosed area (e.g., a room or building) may be controlled (e.g., fan, heater, cooler, humidifiers, air conditioning unit, chiller, blinds, etc.).

The perceived temperature is affected by several factors. For instance, if the outside temperature is low, then a heater will need to turn on more frequently or longer to maintain a temperature setting. The frequency and amount of time in which the heater is on affects the temperature actually felt in the room which can be hotter or colder as the temperature fluctuates and air mixes. Thus, in a traditional thermostat, setting an inside temperature to 75 degrees when the outside temperature is 20 degrees would provide an perception of inside temperature that is different from that when the inside temperature setting is set to 75 degrees and the outside temperature is 70 degrees.

Humidity also plays a role in perceived temperature. For example, a humid room will feel much different than a non-humid room during a heating or cooling operation. (e.g., see the Heat Index chart at www.nws.noaa.gov/om/heat/index.shtml), the entirety of which is incorporated herein by reference. In addition, the amount of radiant heating (e.g., solar heating) received in the room can alter the perceived temperature.

In addition, the temperature and the flow rate (which can depend on the fan speed of the climate control device) of the air at the output of the climate control device will also affect the perceived temperature if that air comes directly into contact with the room occupants (e.g., see the Windchill chart at www.nws.noaa.gov/om/winchill/), the entirety of which is incorporated herein by reference.

An exemplary embodiment of the invention may control an HVAC system 3 based on not just a set or desired temperature, but also on the outside temperature, inside temperature, inside humidity, room geometry, temperature and flow rate at air vents, and other factors. Any appropriate sensor(s) 2 may be used to detect or determine the humidity, inside temperature, outside temperature, radiant heating (e.g., solar heating), and etc. In addition, it is possible to have multiple thermostats communicate so as to coordinate schedules and data using a protocol such as BACnet (e.g., see www.bacnet.org, the entirety of which is incorporated herein by reference).

An exemplary aspect of the invention calculates a schedule for running the HVAC system 3 based on the building/room size and/or geometry, inside and outside temperature, humidity, heating or cooling capacity of the HVAC system, minimum and maximum cycle time for the HVAC system, air flow rates, air flow, etc.

For instance, in an exemplary embodiment of the invention the thermostat 1 measures both outside temperature Tₒ and inside temperature Tᵢ and estimates the schedule of turning the HVAC system 3 on or off to allow the inside temperature Tᵢ to reach the desired temperature T_{d} over a period of time H. This schedule is denoted S(t)=F(Tₒ, Tᵢ, T_{d}, H) and is typically an indicator function of time.

Based on the value of S(t), the system can estimate a perceptual temperature factor W of the schedule and adjust T_{d}: T_{d}←T_{d}+W. The perceptual temperature factor is somewhat similar to a “wind chill” factor (e.g., see www.en.wikipedia.org/wild/Wind_chill, the entirety of which is incorporated herein by reference) or a “heat index” factor mentioned above, in that it is used to calculate the perceived temperature. This new schedule S(t) is then used to control the HVAC system.

In an exemplary embodiment, a new S(t) is computed and the process iterated to arrive at the final schedule S(t). There are several ways to do the iterations. One way is to iterate S(t) over the entire period of interest until a fixed point is obtained. Another way is to solve the implicit function S(t)=F(Tₒ, Tᵢ, T_{d}, S(t), H) using numerical analysis. For instance, one method is to use Newton's method to solve for the value of S(t) (e.g., see www.en.wikipedia.org/wiki/Newton's_method, the entirety of which is incorporated herein by reference). Yet another way is to calculate S(t)=F(Tₒ, Tᵢ, T_{d}, H) for a short period of time and use the adjusted T_{d} to calculate the schedule for the next period of time.

The estimation of the schedule S(t) can be based on thermal and heat transfer models of the building or empirical data collected over time and may require knowledge of the HVAC capacity (BTU/Hr) as well. Examples of such modeling can be performed using computer tools such as Autodesk Revit (www.autodesk.com/products/autodesk-revit-family/overview) or Energy Plus (www.appsl.eere.energy.gov/buildings/energyplus/), the content of each of which is incorporated by reference in its entirety.

The curve W=W(S(t),Tᵢ), used to estimate the adjustment factor W, can be determined using psychological experiments. For instance, there could be a relationship between the duty cycle of S(t) and W. The function W could also depend on the desired temperature T_{d}. The function W could also depend on factors such as the amount of solar heating in the room and the humidity. Another way to determine the function W is record how users adjust the thermostat temperature setting in a traditional thermostat depending on the original thermostat setting, the indoor temperature, and the outdoor temperature. Implementation of the curve W can be done either by computations using equations or via a table lookup, similar to the tables for “wind chill” factor or “heat index” mentioned earlier, which are 2-D tables. In an exemplary embodiment, these tables may have more than 2 dimensions.

In an exemplary embodiment, the schedule S(t) can be determined without the need of outside temperature Tₒ by using historical data about heating schedules of the same room or of room of similar dimension and structure, T_{d} and Tᵢ(t).

In addition, the determination of S(t) can include constraints on the HVAC system(s) 3 such as minimum rest time, minimum run time, energy usage, etc.

An exemplary method is illustrated in FIG. 2. In the exemplary embodiment, the desired temperature, the inside temperature and the outside temperature of the area is acquired (S1). For example, the desired temperature can be the temperature the thermostat 1 has been set to be a user. Next, a schedule S(t) is determined (S2). The schedule S(t) can be determined using any of the factors described. The perceptual temperature factor W is then calculated or looked up using, for example, the schedule and the inside temperature (S3). The desired temperature is then adjusted using the perceptual temperature factor (S4). Optionally, the calculation of the schedule can then be iterated by repeating steps S2-S4, as illustrated by the dashed line. Once the desired iterations are complete, if applicable, the final schedule is calculated using the final adjusted temperature (S5). The final schedule is then used to control an HVAC system(s) 3 for the area (S6). Of course, the method of iteration and variables used in the calculations can be adjusted based on the various embodiments described herein.

By using the above factors, the system can turn on and off a HVAC system(s) 3 at intervals while attempting to reach the desired adjusted temperature in order to maintain a comfortable environment.

While the invention has been described in terms of exemplary embodiments, those skilled in the art will recognize that the invention can be practiced with modification within the spirit and scope of the appended claims

Further, it is noted that, Applicant's intent is to encompass equivalents of all claim elements, even if amended later during prosecution.

Having thus described our invention, what we claim as new and desire to secure by Letters Patent is as follows:

1. A method of controlling a temperature of an area, the method comprising:
determining a schedule for a climate control device needed for an inside temperature to reach a desired temperature;
determining a perceptual temperature factor based on at least the schedule and the inside temperature;
adjusting the desired temperature based on the perceptual temperature factor; and
after the adjusting the desired temperature, determining the final schedule.

2. The method according to claim 1, wherein the determining of the perceptual temperature factor comprises looking up the perceptual temperature factor in a table based on the schedule and the inside temperature.

3. The method according to claim 1, wherein the determining the perceptual temperature factor is further based on at least one of humidity of the area, outside temperature, radiant heating of the area, geometry of the area, and the desired temperature.

4. The method according to claim 1, wherein the determining the schedule is further based on at least one of a constraint related to the climate control device, thermal and heat transfer models of the area, and empirical data related to the area.

5. The method according to claim 1, further comprising iteratively repeating the determining the schedule, the determining the perceptual temperature factor, and the adjusting the desired temperature.

6. The method according to claim 1, wherein the determining the perceptual temperature factor further includes calculations evaluating equations based on the schedule and the inside temperature.

7. A thermostat comprising:
a temperature sensor input unit configured so at to receive a temperature of an area;
a desired temperature input unit;
a control unit configured so as to output a control signal to a climate control device; and
a processor configured so as to determine a schedule for the climate control device and which adjusts the desired temperature based on a perceptual temperature factor,
wherein the perceptual temperature factor is determined based on the temperature of the area and the schedule.

8. The thermostat according to claim 7, wherein the processor is configured so as to receive humidity information of the area, and
wherein the perceptual temperature factor is further based on the humidity information of the area.

9. The thermostat according to claim 7, wherein the perceptual temperature factor is further based on radiant heating information of the area.

10. The thermostat according to claim 7, wherein the processor is configured so as to determine the schedule and adjust the desired temperature iteratively.

11. The thermostat according to claim 10, wherein the processor is configured so as to receive temperature information of an outside area, and wherein the schedule is further based on the temperature information of the outside area.

12. The thermostat according to claim 7, wherein the schedule is further based on constraints related to the climate control device.

13. The thermostat according to claim 7, wherein the schedule is further based on historical schedule data.

14. A non-transitory programmable storage medium tangibly embodying a program of machine-readable instructions executable by a digital processing apparatus to perform a method, the method comprising:
receiving a desired temperature and a temperature of an area;
determining a schedule for a climate control device based at least on the desired temperature and the temperature of the area;
determining a perceptual temperature factor based on at least the schedule and the temperature of the area;
adjusting the desired temperature based on the perceptual temperature factor;
after the adjusting the desired temperature, repeating the determining the schedule; and
sending instructions to the climate control device based on the schedule.

15. The method according to claim 14, further comprising receiving humidity information of the area,
wherein the perceptual temperature factor is further based on the humidity information of the area.

16. The method according to claim 14, further comprising receiving radiant heating information of the area,
wherein the perceptual temperature factor is further based on the radiant heating information of the area.

17. The method according to claim 14, wherein the adjusting the desired temperature and repeating the determining the schedule is repeated iteratively.

18. The method according to claim 14, further comprising receiving temperature information of an outside area,
wherein the schedule is further based on the temperature information of the outside area.

19. The method according to claim 14, further comprising receiving or looking up in a memory constraints related to the climate control device,
wherein the schedule is further based on the constraints related to the climate control device.

20. The method according to claim 14, further comprising receiving historical schedule data,
wherein the schedule is further based on the historical schedule data.
